(19) United States
(12) Patent Application Publication
(10) Pub. No.: US 2012/0090345 A1
(43) Pub. Date: Apr. 19, 2012

(54) OPERATING RESOURCE STORE, HEAT TRANSFER DEVICE, AND HEATING PUMP

(76) Inventors: Hans-Heinrich ANGERMANN, Stuttgart (DE); Roland BURK, Stuttgart (DE); Eberhard ZWITTIG, Hochdorf (DE)

(21) Appl. No.: 13/250,116

(22) Filed: Sep. 30, 2011

Related U.S. Application Data
(63) Continuation of application No. PCT/EP2010/054038, filed on Mar. 26, 2010.

(30) Foreign Application Priority Data
Mar. 31, 2009 (DE) DE102009015102.8
May 5, 2009 (DE) DE102009019712.5

(51) Int. Cl. F25B 30/00; F28F 7/00; B32B 3/30; B01D 53/02

(52) U.S. Cl. 62/324.1; 96/135; 165/185; 428/600

(57) ABSTRACT

heating pump is provided that has a plurality of heat transfer devices, each having at least one first zone and one second zone for displacing an operating resource arranged in the heat transfer device based on thermodynamic state variables. Each of the heat transfer devices are thermally connectable by the first zone thereof to a first flow channel through which a first fluid can flow and by a second zone thereof to a second flow channel through which a second fluid can flow, so that heat energy can be exchanged between one of the fluids and one of the zones. The flow channels of one of the zones can be interconnected to one another sequentially by a valve arrangement and an interconnecting sequence changes in the course of an operation of the heat pump by the valve arrangement.

This nonprovisional application is a continuation of International Application No. PCT/EP2010/054038, which was filed on Mar. 26, 2010, and which claims priority to German Patent Application Nos. DE 10 2009 015 102.8, which was filed in Germany on Mar. 31, 2009, and to DE 10 2009 019 712.5, which was filed in Germany on May 5, 2009, and which are herein incorporated by reference.

### BACKGROUND OF THE INVENTION

1. Field of the Invention

The invention relates to a working medium accumulator comprising a sorbent, a working medium accumulator having capillary gap regions, a heat exchanger having two working medium accumulators, and a heat pump.

2. Description of the Background Art

EP 1 918 668 A1 describes capillary structures for receiving a fluid.

WO 2007/068481 A1, which corresponds to U.S. Publication No. 20090000327, which is incorporated herein by reference, and which describes a heat pump composed of a securely interconnected stack of plate-type hollow elements, wherein the hollow elements comprise adsorber-desorber regions and evaporation-condensation regions, and flow ducts for heat-transferring fluids in thermal contact are provided on the hollow elements. The flow ducts are interconnected in series via pairs of rotating valves.

Such a heat pump has many possible applications, e.g. waste heat recovery in stationary applications, e.g. building technology, solar air conditioning, power-heat-cold coupling systems, or mobile or standstill air-conditioning systems for vehicles, in particular commercial vehicles.

The hollow elements of the known heat pump can be heat exchangers, wherein the heat is transferred as latent heat of the working medium between the adsorber/desorber region and the evaporator-condensation region.

### SUMMARY OF THE INVENTION

It is therefore an object of an embodiment of the present invention to provide a working medium accumulator that has a large storage capacity and high charging and discharging kinetics.

This problem is solved for a working medium accumulator comprising a sorbent according to the invention. In contrast to purely non-positive or form-fit connections, the connection of sorbent and sheet layer which is not necessary, but which is bonded in an embodiment, enables simple and secure assembly as well as improved heat transfer from the working medium via the sorbent to the sheet layer. A sheet layer in the sense of the invention is understood to mean separate sheets as well as sheets of a sheet strip folded in a zigzag pattern, for example. Activated carbon is an example and preferred sorbent, although the invention is not limited to this sorbent. Methanol is a working medium that is possible when activated carbon is used in particular, but that is not necessary. In an embodiment, the sheets can be composed of copper, wherein the further, thermally contacted structures are composed of brass and are soldered with the copper sheets, in particular being brazed. The brazing can take place using known methods, such as “cuprobraze”. Flux can be omitted in the region of the sheets. Measures such as vibrations and/or protective atmospheres or forming gas atmospheres can be implemented to reduce the surfaces during soldering, to prevent oxidation, and/or to scarify oxide layers.

In an embodiment, the sorbent can be in the form of a molded article that has been extruded in particular, whereby optimal filling of the available space can be achieved and, simultaneously, transport ducts for the supply and discharge and distribution of working medium can be formed. Activated carbon can be extruded, for example, as a mixture of pulverized activated carbon with a binding agent which can be carbonized preferably after manufacture and/or the bonded connection of the molded article. The molded article can be strip-shaped or a flat cube in particular.

In a further embodiment, the sorbent can be applied not as an extruded molded article but as a monolayer of a granulate or particle layer onto both sides of the metal carrier rib in a bonded manner, in particular using an adhesive or binding agent, in a manner such that every particle has direct thermal contact with the metal carrier, and the metal carrier has a high loading density. It can be advantageous to apply the coating using a fluidized process, for instance, first using a larger particulate size fraction of the adsorber, followed by a smaller particulate size fraction of the adsorber. The adsorber particles can be fragmented granules, balls, formed pellets, and staple fibers or a combination or mixture of these forms.

In a further embodiment, at least one of the two sorbents or sheet layers connected to the sorbent comprises a patterning with regard to a direction of thermal expansion. Such patterning makes it possible to compensate thermally induced material expansions without the sorbent flaking off of the sheet layer. In one possible example, the patterning includes transverse grooves in sorbent that is often brittle, which serve as predetermined breaking points, for example, and function simultaneously as steam ducts for the working medium. In a further, alternative, or supplementary example, the sheet layer includes transverse grooves or similar folds that can accommodate the thermal expansion.

In general, thermal material stresses occur not only during operation of the working medium accumulator, but also during production. For example, within the scope of soldering of the sheet layers, for example, in a soldering furnace, a greater thermal material stress with respect to the sorbent which is preferably applied in a bonded manner can occur than is the case during operation of the working medium accumulator.

Advantageously, the patterning can therefore be in the form of notches or grooves in the sorbent in order to provide predetermined breaking points to prevent flaking.

In an embodiment, alternatively or additionally, the sorbent can have anisotropic elasticity and/or thermal conduction, wherein, in a preferred detailled embodiment, a mechanical weakening is formed parallel to a direction of thermal expansion of the sheet layer. Such a directional weakening can enable the sorbent to break into clumps when the sheet layer undergoes thermal expansion, for example, wherein the individual clumps remain bonded to the sheet layer. A break-up or disintegration into such clumps, which are oriented substantially perpendicularly to the sheet layer, also facilitates the exchange of working medium with the sorbent across the thickness of the sorbent layer. In a preferred embodiment, the sorbent is a fibrous or plate-shaped additive which is oriented relative to the anisotropy, in order to create such an anisotropic elasticity and/or thermal conduction. The sorbent can be activated carbon, and the additive can preferably be carbon fiber and/or graphite platelets.

In an alternative or further embodiment, the patterning can be in the form of undulation, thereby enabling a thermal expansion of the sheet layer to be accommodated at least in part by the undulation. In a preferred detailled embodiment, two or more undulations having different orientations cross over one another, thereby forming contact islands that are bonded to the sorbent. Such structures in the sheet layer can be manufactured easily and cost-effectively, for example, in a quasi-continuous manufacturing step using engraved rollers. The undulation can have various shapes, such as sinusoidal, rectangular, trapezoidal, or as a type of pleating with overlapping sections.

The further structures can be in the form of tubes, in particular flat tubes, wherein passages are formed in the sheet layers for passage of the tubes. In this manner, latent heat from the working medium can be exchanged with a heat-transferring fluid flowing in the tubes. The fluid can be liquid, gaseous, or multiphase (wet steam), depending on the application.

In an embodiment of the invention, the sheet layers have a surface that has been roughened preferably galvanically at least in the region of the bonded connection to the sorbent. The roughening can be created in another manner, such as via etching. Using galvanic methods, however, a particularly suitable patterning can be created by growing crystallites that are column-shaped, for example. The roughening enables a good, at least partially form-fit, bonded connection with the sorbent to be attained, wherein heat transfer is also improved due to larger contact surfaces.

As an advantage, in general, the bonded connection withstands temperatures above 300° C., wherein it is preferably formed using at least one of the two, anorganic adhesive or carbonized organic adhesive. As a result, the sheet layers, for example, can be soldered, in particular brazed, to the further structures after the sorbent is applied. An anorganic adhesive can be understood to be a silicate-based adhesive, for example, such as water glass. In the case of organic adhesives, those that contain a high portion of carbon, such as phenolic resins, are preferred. These adhesives make stable carbonization possible, e.g. by heating in a protective atmosphere. The carbonization of the adhesive can take place, in particular, within the scope of a brazing of components of the working medium accumulator in a soldering furnace.

The problem addressed by the invention is also solved for a working medium accumulator having capillary gaps for the storage of a condensed phase of the working medium. Large quantities of working media can be stored easily and cost-effectively by layering the patterned sheets, which have direct contact with one another, in a stacked manner.

In one possible embodiment, each of the patterned regions comprises a plurality of grooves. In an alternative or supplemental embodiment, each of the patterned regions can include a plurality of nubs.

In an embodiment, the structured regions adjoin main steam ducts formed between the sheet layers. In a detailled embodiment that is preferred but not necessary, the main steam ducts extend adjacent to the structure contacted in a thermally conductive manner. This structure can be fluid-conducting tubes in particular, such as flat tubes that are routed through passages in the sheet layers.

In an embodiment, at least two main steam ducts are formed between two of the sheet layers, wherein at least one of these main steam ducts has a larger cross section. When the working medium accumulator is saturated, the main steam duct having the larger cross section, at the least, is preferably not full during operation, thereby ensuring that good circulation of vaporous working medium between the sheet layers is given at all times.

In an embodiment, the surfaces of the sheet layers comprise machining for improving wettability with the working medium, in particular using galvanic treatment. Therefore, simply providing a roughening of suitable dimensions can improve the wetting of the surfaces. The result is faster condensation and evaporation, and improved maximum working medium capacity of the accumulator.

Another problem addressed by the invention is solved for a heat exchanger having two working medium accumulators. In an embodiment, at least one of the working medium accumulators can be in the form of a working medium accumulator.

In an embodiment of the invention, the particular other of the two working medium accumulators can include a first working medium accumulator having a sorbent for the adsorption and desorption of a gaseous phase of the working medium, and a further working medium accumulator for the condensation and evaporation of the working medium.

In an embodiment, the two working medium accumulators can be accommodated in a common housing, wherein the structures, which are contacted in a thermally conductive manner, are in the form of tubes which carry at least one fluid and extend through end-face bases of the housing. In applications of a heat pump, for example, the tubes can carry two different fluids; for instance, the tubes having thermal exchange with the first working medium accumulator carries a liquid, and the tubes having thermal contact with the second working medium accumulator carry a gas, such as air to be air conditioned. These two tubes or tube groups can also have different sizes and cross sections. The fluid- and working medium-tight connection of the tubes to the bases is essential in the sense of the detailled embodiment according to the invention. It is thereby made possible to utilize the advantages of proven design principles of bundle heat exchangers in order to combine them, according to the invention, with a latent heat transfer using working medium accumulators and a working medium.

In an embodiment, the heat exchanger can be in the form of a module, wherein at least two of the modules can be stacked sequentially and in a fluid-tight manner in the direction of the tubes. In this manner, heat exchangers of different sizes and transmission capacity can be manufactured from a module produced in favorable series production, depending on the requirements. In a simple and expedient detailled embodiment, the bases have a sealing surface, wherein the sealing surface interacts with a seal for fluid-tight stacking. The sealing surface can be a circumferential ridge, for example, and the seal can be a flat seal pressed onto the ridge. In another example, the sealing surface is in the form of a groove into which a circumferential annular seal has been placed. In a further preferred development, a cistern can be attached to the base in a fluid-tight manner using the sealing surface. As a result, terminal modules of a module stack do not require a deviating embodiment, either.

As a general advantage, the heat exchanger can include a housing jacket, wherein the housing jacket and the bases enclose a closed hollow space in which the working medium accumulators are disposed. In a simple embodiment, such a housing jacket can be a circumferential sheet strip that is closed at a seam, for instance. The housing jacket can be attached to the bases in a downstream method step in particular, after the working medium accumulators and tubes were brazed to one another, for example. The housing jacket can then be bonded, soft soldered, welded, or brazed, for example.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a spatial full view of a heat pump according to the invention.

FIG. 2 shows an exploded view of the heat pump in FIG. 1.

FIG. 3 shows a top view of the heat pump in FIG. 1 from the side.

FIG. 4 shows a schematic spatial depiction of a heat exchanger according to the invention.

FIG. 5 shows a spatial depiction of parts of the heat exchanger in FIG. 4.

FIG. 6 shows a schematic cross-sectional view of the heat exchanger in FIG. 4 in the region of a first working medium accumulator comprising a sorbent.

FIG. 7 shows a plurality of views of a sheet layer of the working medium accumulator in FIG. 6.

FIG. 8 shows a top view of a variant of the sheet layer in FIG. 7.

FIG. 8a shows a sectional view of a further variant of the sheet layer in FIG. 7.

FIG. 8b shows a sectional view of a further variant of the sheet layer in FIG. 7.

FIG. 8c shows a sectional top view of a further variant of the sheet layer in FIG. 7.

FIG. 8d shows a sectional view of a further variant of the sheet layer in FIG. 7 with various patternings of an adsorbent.

FIG. 8e shows a spatial sectional view of a further variant of the sheet layer in FIG. 7.

FIG. 9 shows a further sectional view and top view of the working medium accumulator in FIG. 7.

FIG. 10 shows a partial sectional view of a further embodiment of a heat exchanger according to the invention.

FIG. 11 shows an entire schematic sectional view of the heat exchanger in FIG. 10.

FIG. 12 shows a schematic spatial view of the heat exchanger in FIG. 10.

FIG. 13 shows a sectional view of a further embodiment of a heat exchanger according to the invention.

FIG. 14 shows a plurality of views of a sheet layer of a second working medium accumulator having capillary structures.

FIG. 15 shows a sectional view of the heat exchanger in FIG. 6 in the region of a second working medium accumulator having sheet layers according to FIG. 14.

FIG. 16 shows a sectional view of the working medium accumulator in FIG. 15 parallel to the sheet layers.

FIG. 17 shows a plurality of views of a first variant of the working medium accumulator in FIG. 15.

FIG. 18 shows a sectional view of a further variant of the working medium accumulator in FIG. 15 parallel to the sheet layers.

FIG. 19 shows a further embodiment of a second working medium accumulator having capillary structures.

### DETAILED DESCRIPTION

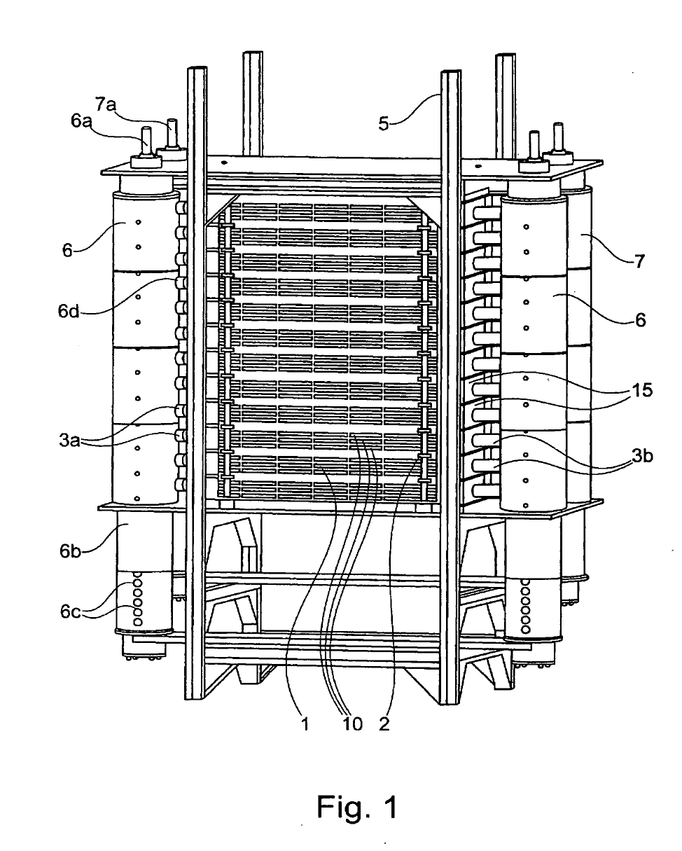

FIG. 1 shows a heat pump in which a plurality of heat exchangers 1, twelve in this case, are disposed parallel to one another in a stacked manner. The stack of heat exchangers 1 is detachably connected via tie rod 2 to form one structural unit.

Each of the heat exchangers 1 comprises a first zone A in the form of an adsorption/desorption zone, and a second zone B in the form of an evaporation/condensation zone. In the first zone A, a first flow duct 3 of a circulating fluid pumped by a non-depicted pump extends through each of the heat exchangers 1, and a second flow duct 4 of the fluid extends through each of the heat exchangers in the second zone B. Each of the flow ducts 3, 4 comprises end-face connectors 3a, 3b which are diametrically opposed and serve as inlets or outlets for fluid flowing through flow ducts 3, 4.

The stack of heat exchangers 1, which is held together via tie rod 2, is disposed in a frame 5 of the heat pump. A total of four rotating valves are disposed on the outside of frame 5 and are connected to the stack of heat exchangers 1, wherein two substantially identical rotating valves 6 are connected to the supply and discharge lines 3a, 3b, respectively, of sorption side A. Two of the rotating valves 7, which generally differ in particular with respect to the number of flow ducts separated in the valve, but which have an identical design, are connected to the second zone or evaporation/condensation side B of heat exchanger 1.

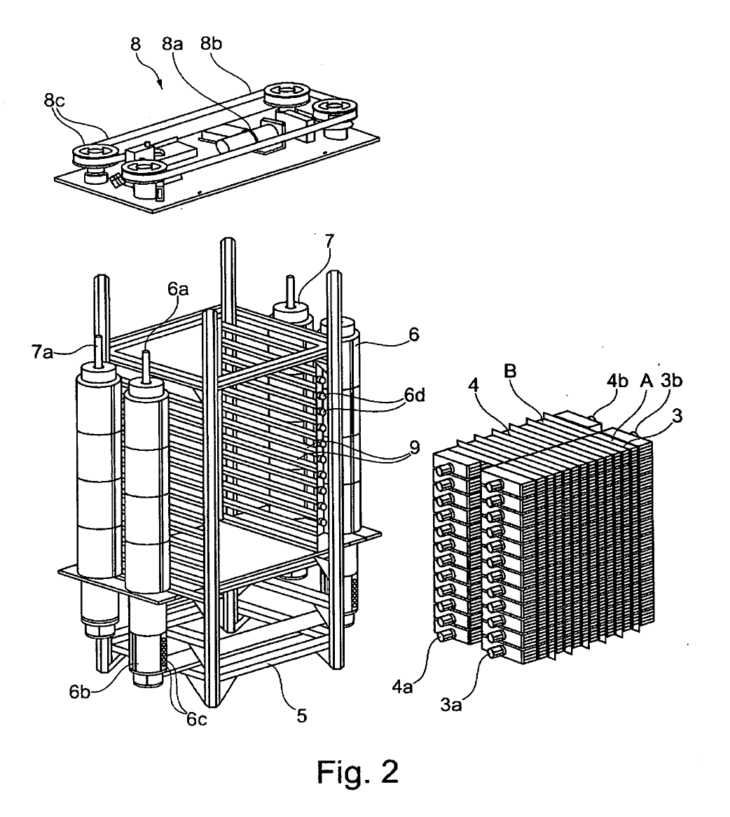

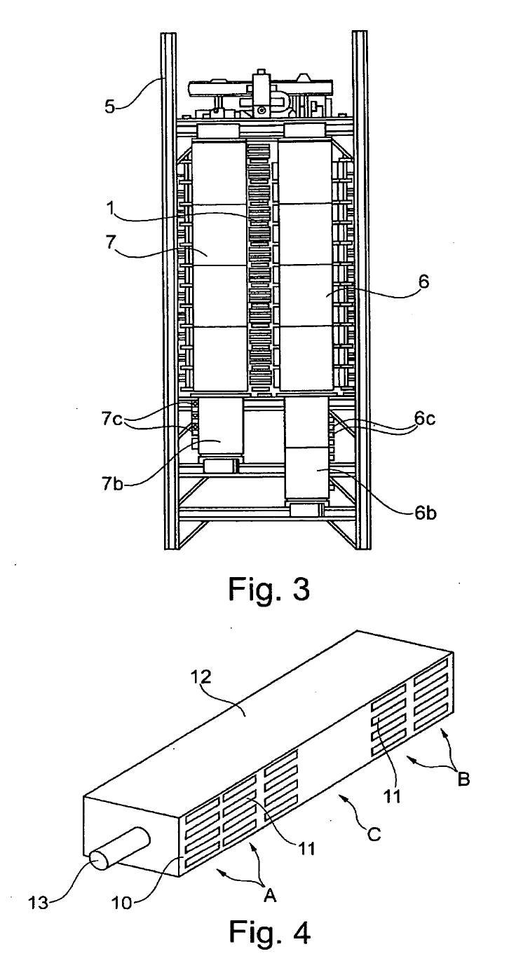

Rotating valves 6, 7 are all oriented parallel to one another, wherein central rotating shafts 6a, 7a of rotating valves 6, 7 are connected to a modular drive unit 8 which is depicted schematically in FIG. 2. Drive unit 8 comprises an electric motor 8a via which four drive wheels 8c for driving particular axles 7a, 6a of rotating valves 6, 7 via a toothed belt 8b are moved in a synchronized manner. In the present design, all rotating valves 6, 7 are driven at the same angular velocity.

Rotating valves 6 of sorption side A of heat exchangers 1 have an inlet region 6b which includes twelve separate inlets, and so each of the twelve heat exchangers 1 corresponds to a separate duct within rotating valve 6. Rotating valves 7 of evaporator side B have a smaller number of separate inlets 7c, i.e. only four, in an inlet region 7b since the separation of the flow ducts on this side of the heat pump usually does not have to be as distinctly differentiated as on the sorption side. Accordingly, a plurality of hollow elements 1, i.e. three in the present case, are connected simultaneously to one of the flow ducts in valves 7 with regard to second zone B thereof. Reference is made in this regard and with regard to the operating method to the explanations provided in the prior art WO 2007/068481 A1.

Adjacent heat exchangers 1 are held at a distance from one another, which is achieved in the present case by way of suitable spacers 9 between the hollow elements. An air gap therefore remains between heat exchangers 1, and so they are thermally well insulated from one another. To further improve the thermal insulation, insulating boards which are not depicted and can be made of foamed polymer or fibrous insulating material can be inserted.

Individual connectors 3a, 3b, 4a, 4b of heat exchangers 1 are connected to corresponding connectors 6d, 7d of rotating valves 6, 7 which, oriented in a row, extend radially from the walls of an outlet region of the substantially cylindrical rotating valves. To offset thermally induced expansions of the heat pump, connectors 7d, 6d of rotating valves 6, 7 are connected to connectors 3a, 3b, 4a, 4b of the stack of heat exchangers 1 via elastic connecting pieces, e.g. tube pieces or corrugated bellows.

According to FIG. 4, heat exchangers 1 of the heat pump are designed such that a working medium accumulator is disposed on a sorption side A, and a working medium accumulator is disposed on an opposite evaporation side B in a housing 9. Housing 9 comprises two parallel bases 10 having passages in which the ends of flat tubes 11 are accommodated. Bases 10 are closed off by a circumferential housing jacket 12 to form a hollow space which is impermeable to working medium. One or more filling tubes 13 are provided in housing jacket 12, via which the hollow space can be evacuated and filled with working medium. This can be a permanent filling, in particular, wherein the filling tubes are permanently closed via deformation after filling, for example.

A first group of flat tubes 11 in the region of first working medium accumulator A forms flow duct 3 for a first heat-transferring fluid, and a second group of flat tubes 11 in the region of second working medium accumulator B forms flow duct 4 for a further heat-transferring fluid. A free distance C forms between the groups of flat tubes 11, which performs the function of an adiabatic zone between regions A, B. Thermal conduction should not take place through this zone, if possible, wherein gaseous working medium, as the carrier of latent heat, can be displaced between the working medium accumulators in regions A, B, however.

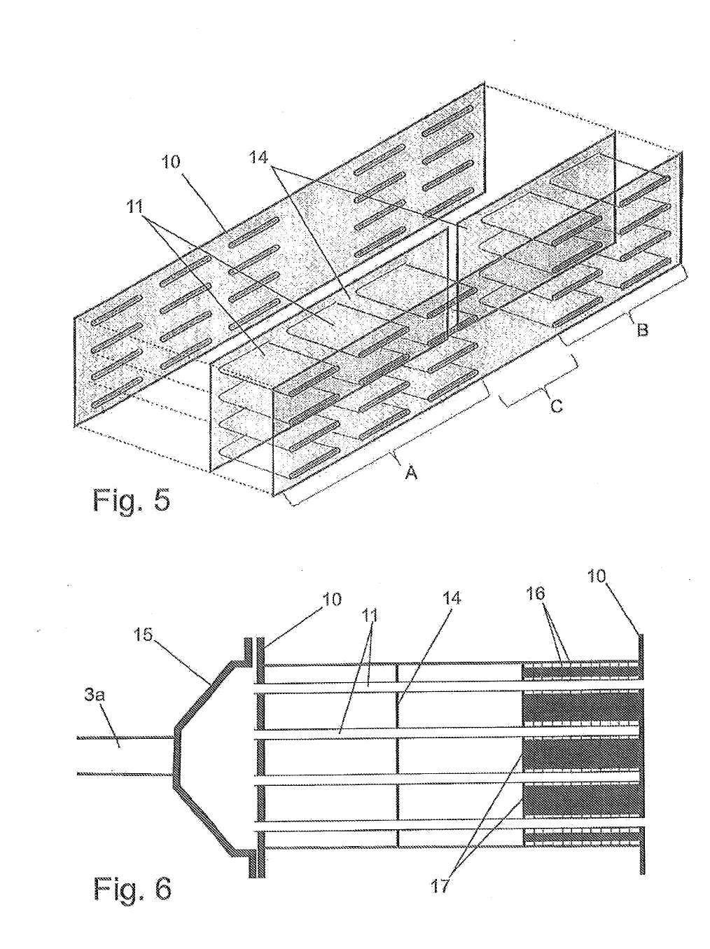

FIG. 5 shows a partial depiction of heat exchanger 1, although the working medium accumulators are not shown. Flat tubes 11 are mechanically supported within the hollow space by further support bases 14 to provide greater robustness against differential pressures of the working medium toward the surroundings. Support bases 14 perform a support function but not a sealing function. The support bases are divided in the region of adiabatic zone C to provide better thermal insulation between zones A, B.

FIG. 6 shows the heat exchanger with an attached collector box 15 which comprises end-face connectors 3a for the first, sorption-side fluid.

The sectional view shown in FIG. 6 extends through first region A and the first working medium accumulator. It is composed of a stack of parallel sheets or sheet layers 16 of copper sheets, on each of which strips of a sorbent are attached to one or both sides, depending on the requirements.

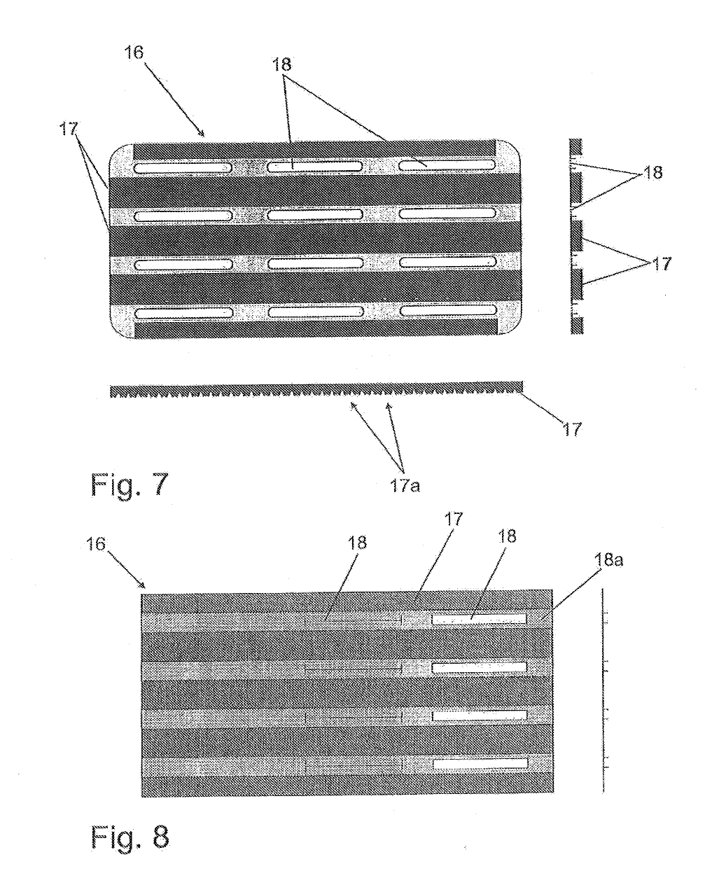

FIG. 7 shows a plurality of top views of one of the sheets 16. The copper sheet has a thickness in the range of 0.01 to 1 mm, but preferably no more than approximately 0.1 mm.

The sorbent is activated carbon which was extruded to produce molded articles in the form of strips 17. Strips 17 have a preferred thickness in the range of 0.5 mm to 2.5 mm, preferably approximately 1.5 mm. As a result, a good ratio is established between active masses (sorbent) and passive masses (sheets) of the working medium accumulator, wherein effective heat transfer is ensured in the adsorption or desorption of the working medium. The working medium is methyl alcohol (methanol) in the present embodiments.

Activated carbon strips 17 are attached to copper sheet 16 in a bonded manner, in particular using an adhesive, to ensure the greatest possible thermal contact.

Rows of passages 18 through which flat tubes 11 extend are formed between activated carbon strips 17. The flat tubes are composed of brass in the present case. They are brazed in the contact regions thereof with passages 18 of sheets 16, e.g. using the “cuprobraze” soldering method. In this case, sheets 16 are composed of copper, and tubes 11 are composed of brass having a zinc portion of 14%, and are soldered. Optionally, etching can be carried out before soldering, to improve wetting.

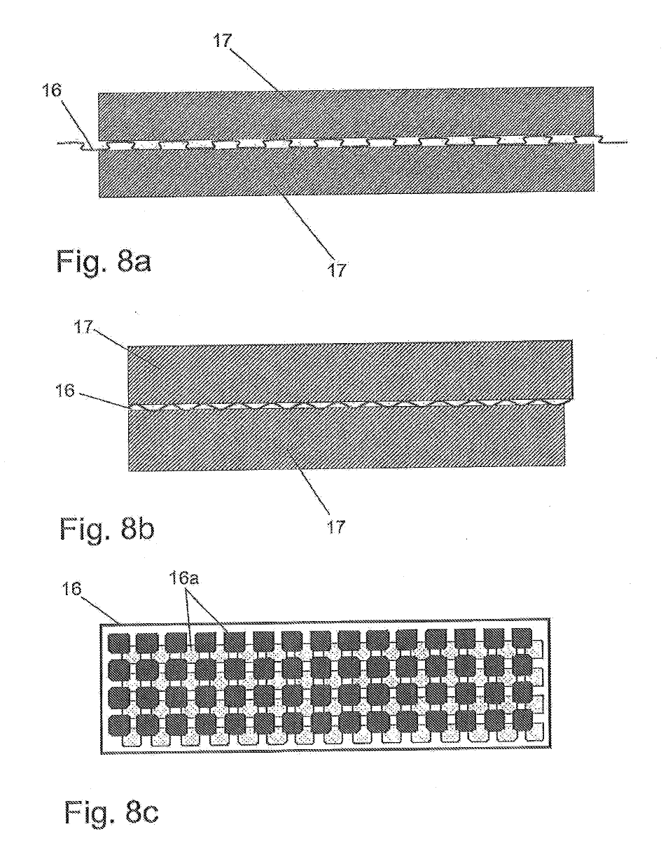

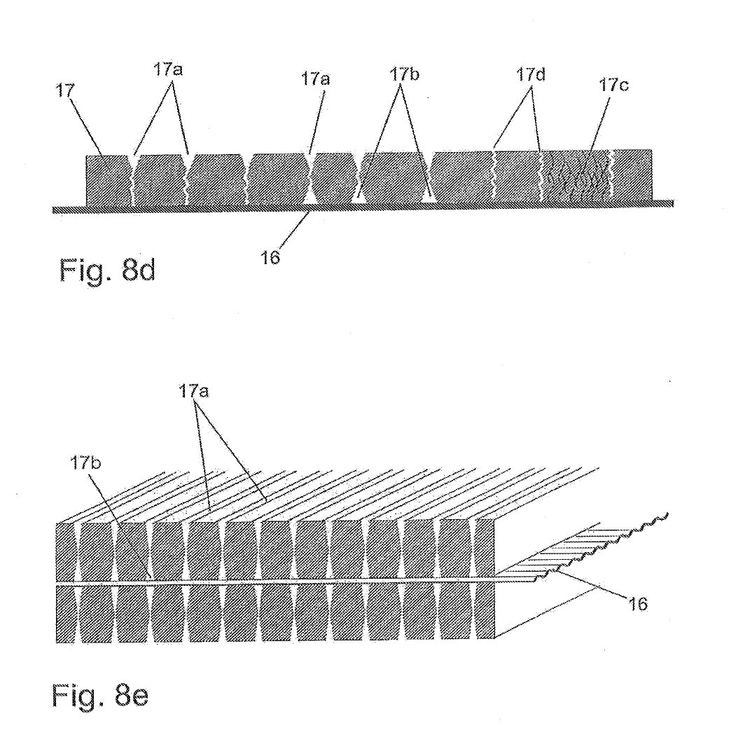

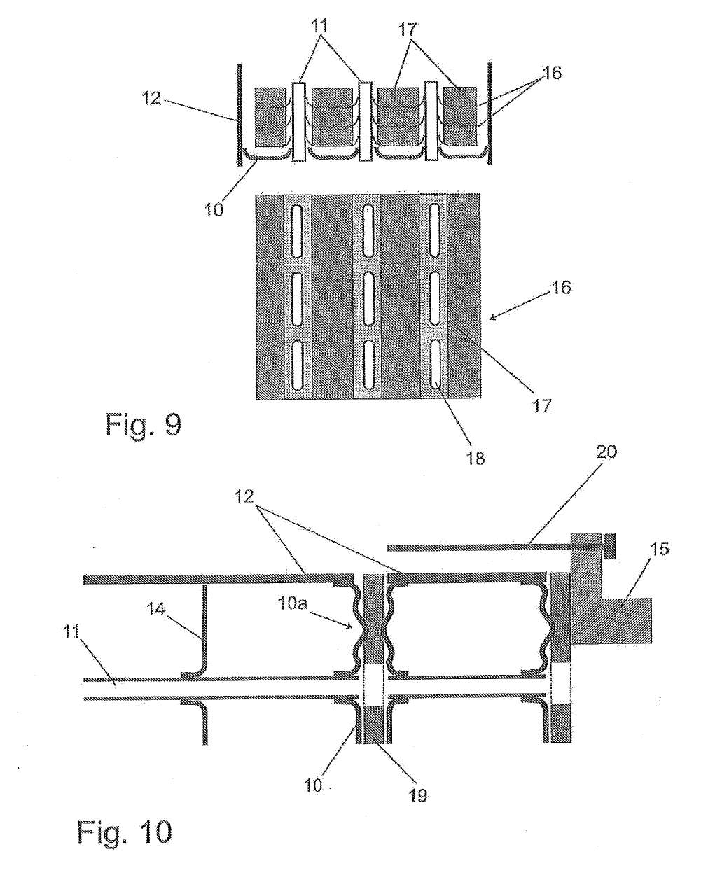

As an alternative to the brazing method, soft soldering method can be used, in which sheets 16 in the region of tube passages 18 are only partially presoldered (e.g. local tin-plating) in regions 18a (see FIG. 8) of tube passages 18. For this purpose, it is provided that a strip is cut using a roller in accordance with the zone shown in the center in FIG. 8, and, in a further step, the tabs are bent backward. This step can also take place after sheets 16 are compartmentalized and directly before or while tubes 11 are slid through. In this joining procedure, the brass tubes are also soldered, at least externally. After flat tubes 11 are slid through, the soldered sheet parts come in contact with soldered tubes 11 and form a bonded connection when the melting temperature is reached, preferably in a protective atmosphere without additional flux. To support the flow process, it is possible to use additional measures that remove the oxide layer, such as mechanical vibrations or a reductive gas atmosphere. It is also possible to carry out an etching process immediately before soldering.

Tubes 16 are structures that are contacted to sheet strips 16 in a thermally conductive manner, via which heat exchange takes place. Heat is exchanged via the tubes with the heat-transferring fluid which is approximately a water-glycol mixture in the present case.

In the case of soldering sheets 16, in particular, the bonded connection between sheets 16 and sorbent 17 is designed to be resistant to high temperature, in particular temperatures above 300° C. This takes place preferably by using an anorganic adhesive based on silicate (e.g. water glass), for instance. Alternatively, an organic adhesive can also be used, which is carbonized after activated carbon strips 17 are applied, e.g. during brazing. In carbonization, hydrogen is split off using heat, and a carbon skeleton of the adhesive having sufficient mechanical stability remains. Well-suited organic adhesives such as phenolic resins usually have a high carbon density for this reason.

The surface of sheet 16 is roughened, at least in areas, to improve the bonded connection. This takes place in the present case by using a controlled galvanic method, using which microcrystallites of high aspect ratio are grown on the surface.

Activated carbon strips 17 have a patterning on the top side thereof with respect to a direction of thermal expansion in the form of transverse corrugation 17a. The notches of the corrugation serve as predetermined breaking points to prevent activated carbon 17 from flaking off of sheets 16 if excessive thermal expansion occurs. At the same time, the notches of the transverse corrugation form additional steam ducts to ensure optimal transport of steam into and out of the activated carbon.

FIG. 8a shows one possible detailled embodiment of a patterning of sheet layer 18, which is in the form of pleating having overlapping flanks. As a result, the thermal expansion of sheet 16 can be offset particularly well, e.g. while the components are being soldered in the soldering furnace (temperatures typically above 600° C.). The contact surfaces or bonded connection between activated carbon molded articles 17 and sheet layer 16 is strip-shaped perpendicular to the direction of the drawing.

FIG. 8b shows the arrangement in FIG. 8a, although the undulation created in sheet layer 16 is sinusoidal and not overlapping.

FIG. 8c shows one possible embodiment, in which an undulation was formed in sheet layer 16, crossing over itself in two directions perpendicular to one another, and so contact islands 16a protrude from both sides of the sheet plane (filled/unfilled squares). This permits compensation of the thermal expansion in a plurality of directions.

Three different ways to structure the sorbent or activated carbon strips 17 are shown in the same image in FIG. 8d.

In the left region, notches 17a are formed only in the surface of activated carbon 17 that is not connected to sheet 16. These notches form predetermined breaking points at which the activated carbon can break substantially perpendicularly to the plane of the sheet (see predetermined breaking points indicated). This prevents activated carbon 17, which is connected in a bonded or adhered manner, from flaking off, e.g. during a brazing procedure during manufacture of the working medium accumulator.

Notches 17b, which are aligned with upper notches 17a in particular, are also provided on the side connected to sheet layer 16, as shown in the center region of FIG. 8d. This improves the function of the predetermined breaking point and results in improved transport of the working medium near the sheet plane. In a further embodiment (not depicted), notches 17b can be provided only on the sheet side.

The integration of a directional additive 17c in the activated carbon is indicated in the right region of FIG. 8d. Additive 17c can be composed of carbon fiber and/or graphite platelets, for example. The orientation is substantially perpendicular to the plane of sheet layer 16, thereby enabling the activated carbon to break more easily in the direction of sheet layer 16 than perpendicularly thereto. The additive therefore brings about an anisotropy or anisotropic elasticity or breaking strength of the activated carbon.

When sheet layer 16 undergoes thermal expansion, microcracks 17d form, which extend perpendicularly to sheet 16, as do the fibers. The activated carbon therefore disintegrates into clumps of arbitrary sizes, which remain bonded to sheet 16 in the base region. Cracks 17d also improve the transport of the working medium. The directionally applied additive 17c can also improve thermal conductance through the activated carbon in the direction perpendicular to the sheet plane.

Sorbent strips containing an additive directed perpendicularly to the strip plane can be manufactured as follows, for example.

A mixture of activated carbon powder, binding agent, and additive (carbon fibers and/or graphite platelets) is pressed in an extrusion direction, thereby orienting the additive in the direction of extrusion. At an outlet, disks are cut off perpendicularly to the outlet or extrusion direction, which form the activated carbon molded articles directly or after a further cut. Sintering is then carried out at temperatures of a few hundred ° C., at which the binding agent carbonizes, usually accompanied by a certain amount of shrinkage of the molded articles, and solid, hard activated carbon strips are obtained.

These strips are bonded onto sheet strips 16, e.g. using an organic adhesive such as phenolic resin or an anorganic adhesive such as water glass. In the case of an organic adhesive, melting and optional carbonization of the adhesive can take place during a soldering procedure or in a preceding, separate process step.

It is understood that the individual measures shown in FIG. 8 to FIG. 8d can be combined with one another in a reasonable manner. As an example thereof, FIG. 8e shows an arrangement in which metal sheet 16 comprises an undulation as in FIG. 8b, wherein the sorbent or activated carbon strips 17 have notches 17a, 17b extending perpendicularly thereto, as shown in the center in FIG. 8d. in this manner, thermal expansion of sheet 16 can be offset in one direction by breakage of the activated carbon, and in the other direction by undulation of the sheet without activated carbon 17 flaking off of sheet 18. As a result, in the embodiment depicted in FIG. 8e, the activated carbon is connected to sheet 16 via contact islands similar to FIG. 8c.

The patterning of the sorbent and/or the sheet layer is not limited to the above-described examples. In particular, to offset the thermal expansion, the sheet layer can also comprise openings in the manner of a grid, e.g. in the manner of a transverse or expanded metal mesh.

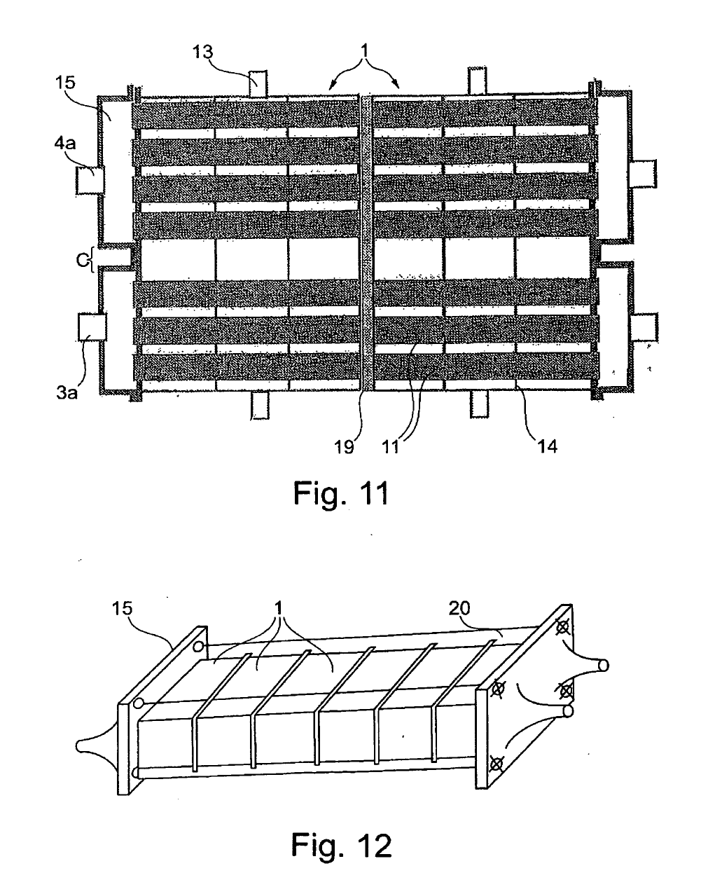

Independently of the specific embodiment of the working medium accumulators in regions A, B, FIG. 10 to FIG. 12 illustrate a design, according to the invention, of heat exchanger 1 as a module that can be stacked in the direction of tubes 11. To this end, at least one of the two bases 10, preferably both bases 10, are equipped with a sealing surface 10a. In the present case, sealing surface 10a is designed as a closed ridge the encloses groups 3, 4 of flat tubes 11. A flat seal 19 against which ridges 10a bear in a sealing manner are inserted between two heat exchangers 1 which are stacked on top of one another. In this manner, flow ducts 3, 4 of the two regions A, B are continuously separated from each other.

A cistern 15, instead of a further heat exchanger 1, can be attached at the end of the stack in the same manner.

The stack of heat exchangers 1 and (optionally) cisterns 15 is held together by tie rods 20 (see FIG. 10 and FIG. 12).

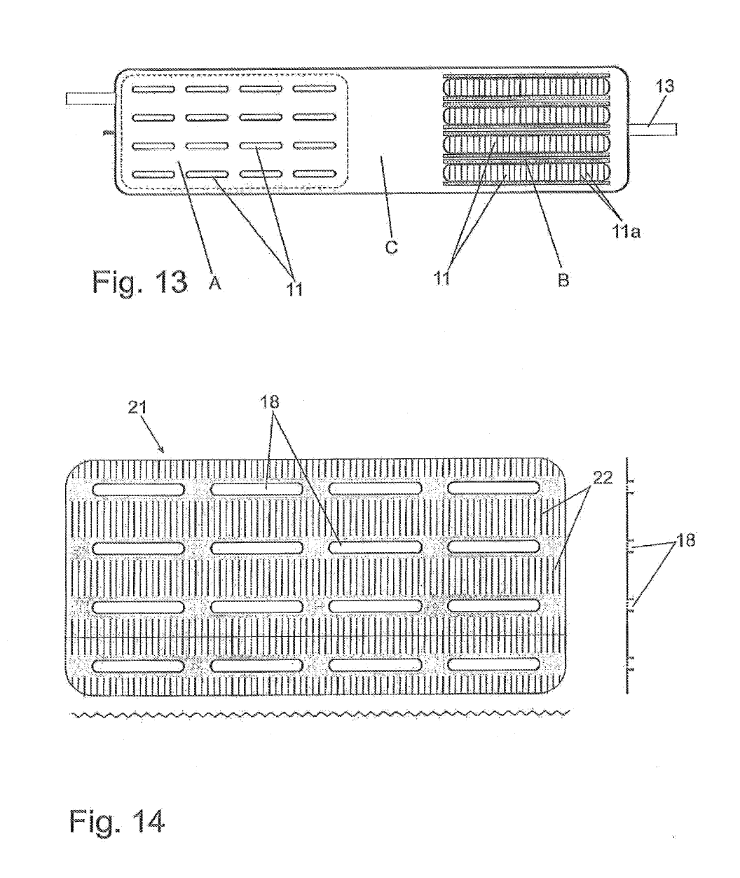

FIG. 13 shows a cross section of a heat exchanger, in which flat tubes 11 of first region A and second region B have different shapes. The first region contains simple, narrow flat tubes through which a liquid fluid having high heat capacity can flow. In second region B, the flat tubes have a much greater cross section as well as internal ribbing 11 a to improve the heat transfer between flat tube 11 and fluid. This is advantageous in the case of gaseous fluids such as air, in particular, which deliver a small heat-capacity flow. The two different working medium accumulators are indicated purely schematically in FIG. 13. The adsorption-desorption working medium accumulator in region A is in thermal contact with the liquid fluid, while the evaporation-condensation working medium accumulator having capillary structures in region B is in thermal contact with the gaseous fluid.

FIG. 14 to FIG. 19 relate to working medium accumulators having capillary structures in which a liquid phase of a working medium can be retained. Basically, such a working medium accumulator can be embodied independently or, as in the specific examples presented here, integrated in a heat exchanger 1 which is used in the present case to build a heat pump (with fluid control as shown in FIG. 1, for instance, although this is not necessary).

FIG. 14 shows a plurality of views of a sheet layer or a sheet 21. Rows of passages 18 through which tubes 11 extends are provided in sheet 21. Strip-shaped, patterned regions 22 are provided between the rows, wherein the patternings are formed by corrugations or micro-undulations in the present case. In general, such patternings can be formed in the sheet using a rolling step, in particular using a continuous method.

Sheets 21 are stacked one on top of the other, in parallel, with direct contact, to form a working medium accumulator; when a packet of sheets is stacked, capillary gaps that retain condensed working medium via capillary force form at the undulations which are supported against one another as mirror images.

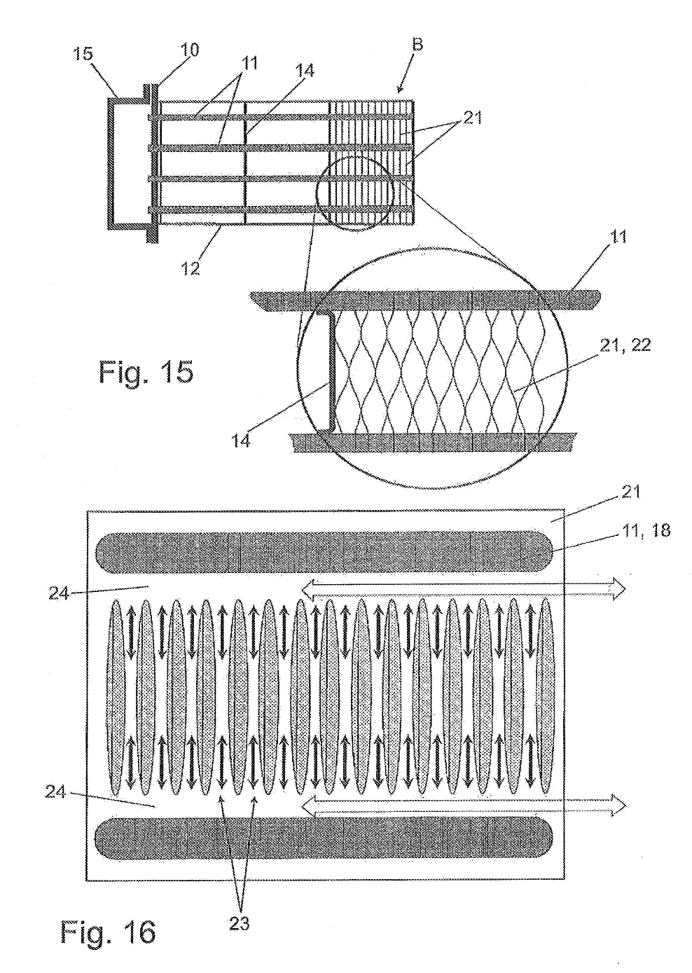

FIG. 15 shows a section through a heat exchanger 1, the design of which was described above, in region B of the second working medium accumulator. Furthermore, an enlarged view is shown, which shows the stacked micro-undulations 22, which are in contact with each other.

FIG. 16 shows the function of the working medium accumulator in greater detail. The undulations are indicated in the sectional view as perpendicular, straight lines. The oval regions enclosing the lines represent working medium that is condensed and is held in the gap by capillary action. The arrows show the flow paths of the vaporous working medium. Smaller steam ducts 23 which lead into main steam ducts 24 extend between adjacent undulations (from the top to the bottom in the plane of the drawing), at least when accumulators are only partially filled. Main steam ducts 24 extend parallel to the rows of flat tubes along the edge of patterned regions 22.

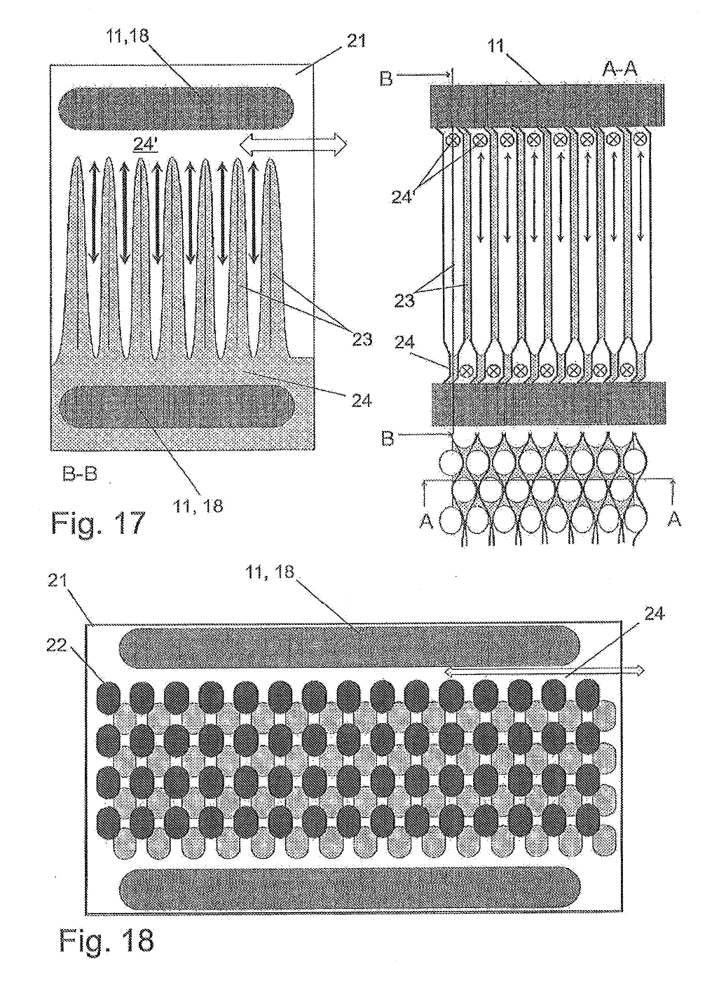

In the variant depicted in FIG. 17, the patternings are formed perpendicularly to the sheet plane in an asymmetrical manner such that some of the main steam ducts 24′ have a larger cross section than the other main steam ducts 24. As a result, as the working medium accumulator fills, smaller main steam ducts 24 fill with fluid first, while large main steam ducts 24′ are the last to be filled, to ensure effective exchange of working medium.

In the example depicted in FIG. 17, broader and narrower sheet distances are generated in alternation in the region of the main steam ducts. This has the advantage that, even when the capillary structures are filled to the maximum with working medium, a main steam duct 24′ between two adjacent sheets always remains open, while narrow duct 24 can be filled completely with fluid. In this manner, mutually comb-shaped liquid bridges (see FIG. 17, left) form, wherein, depending on the plane, the comb tips point upward and then point downward in the adjacent intermediate space. The advantage of this embodiment of the packet of capillary structures is that the entire packet can be filled with fluid up to at least 50 percent by volume without clogging the steam transport system, which represents a very high storage density.

In a further embodiment, as shown in FIG. 18, sheet strips 21 are inserted, which comprise two superposed micro-undulations in the regions between tubes 11. When configured accordingly, the sheets provide each other with punctiform mutual support upwardly at the superimposed wave peaks, and downwardly at the superimposed wave troughs. In an analogous manner, when partially filled with condensate, the fluid bridges shown filled and unfilled are formed in the regions of the narrowest gap. As a result, the available, volume-specific phase interface for evaporation is increased once more. Capillary structures 22 according to FIG. 18 can also be created in sheets 21 via indentation of nubs.

In a further embodiment, the sheets are made of metal foil, in particular copper foil, the surfaces of which are treated such that the structure is wetted as well as possible. This is carried out by galvanic treatment, for example, whereby the entire sheet surface is covered with a liquid film, thereby resulting in another increase of the volume-specific phase interface accompanied by a very thin liquid boundary layer.

In an embodiment which is not depicted here in greater detail, the measures from FIG. 17 and FIG. 18 can be combined, which would result in . . . of a fluid take-up capacity, and a large phase interface.

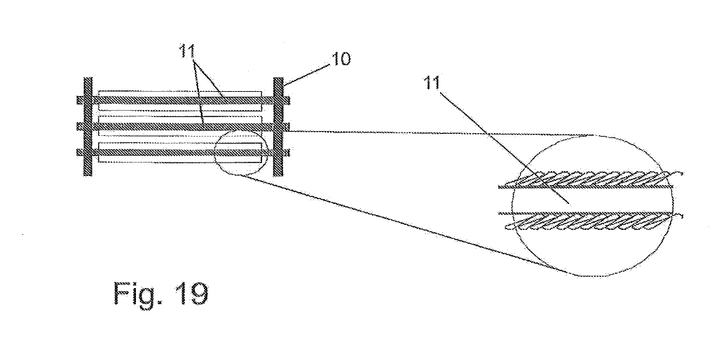

FIG. 19 shows an alternative embodiment of a second working medium accumulator, in which the capillary structures are designed according to the teaching of publication EP 1 918 668 A1. Such structures are also suitable for providing a working medium accumulator, e.g. to form a heat exchanger according to the invention.

To create heat exchangers 11 according to the invention, it is possible to use a combination of various bonding-based joining technologies from the group of brazing, soft soldering, welding and all of the process-related variants thereof. The interconnection of pipes 11, sheet layers 16, 21, and tube bases 10 is preferably soldered using cuprobraze methods, in which the tubes are presoldered. In a second method step, the open block is then completed with the housing jacket 12, preferably using a joining process, in which the presoldered block of tubes and working medium accumulators no longer reaches the original soldering temperature, at least in entirety. Basically any soldering or welding technology can be used for this purpose.

Preferably, in general, the working medium accumulators of regions A, B do not touch housing jacket 12 of heat exchanger 1, which improves the insulation thereof.

It is understood that the special features of the individual embodiments can be combined with one another in a meaningful manner depending on the requirements.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A working medium accumulator comprising:
a plurality of layers of metal sheets, wherein at least some of the sheet layers are contacted with a further structure in a thermally conductive manner, and wherein the sheet layers are disposed one above the other in a stacked manner; and
a sorbent disposed on at least one side of a particular sheet layer for the adsorption and desorption of the working medium, the sorbent having a thermally highly conductive and/or bonded connection with the sheet layer.

2. The working medium accumulator according to claim 1, wherein the sorbent is applied as a monolayer of a granular or particulate layer to both sides of the metal carrier in a bonded manner via adhesion or by using a binding agent.

3. The working medium accumulator according to claim 1, wherein at least one of two layer sheets connected with the sorbent has a patterning with respect to at least one direction of thermal expansion.

4. The working medium accumulator according to claim 3, wherein the patterning is a notch or filling of the sorbent, in particular a crossing over.

5. The working medium accumulator according to claim 1, wherein the sorbent has an anisotropic elasticity and/or thermal conduction, wherein a mechanical weakening is formed parallel to a direction of thermal expansion of the sheet layer.

6. The working medium accumulator according to claim 5, wherein the sorbent is admixed with a fibrous or plate-shaped additive or carbon fiber and/or graphite platelets, which is oriented relative to the anisotropy.

7. The working medium accumulator according to claim 3, wherein the patterning is an undulation or a crossing-over undulation of the sheet layer.

8. The working medium accumulator according to claim 1, wherein the further structure is a tube or flat tube, and wherein passages are formed in the sheet layers for passage of the tubes.

9. The working medium accumulator according to claim 1, wherein the sheet layers have a surface that has been roughened, preferably galvanically, at least in a region of the bonded connection with the sorbent.

10. The working medium accumulator according to claim 1, wherein the bonded connection resists temperatures above 300° C., and wherein the connection is formed using at least one of either anorganic adhesive or carbonized organic adhesive.

11. A working medium accumulator, comprising:
a plurality of layers of metal sheet; and
a further structure contacting at least a few of the sheet layers in a thermally conductive manner, the sheet layers being disposed directly on top of one another in a stacked manner,
wherein at least a few of the sheet layers comprise patterned regions, and
wherein capillary gap regions for storage of a condensed phase of the working medium are formed between successive sheet layers.

12. The working medium accumulator according to claim 11, wherein each of the patterned regions comprises a plurality of grooves.

13. The working medium accumulator according to claim 11, wherein each of the patterned regions comprises a plurality of nubs.

14. The working medium accumulator according to claim 11, wherein the patterned regions border on main steam ducts formed between the sheet layers, and wherein the main steam ducts extend adjacent to the structure contacted in a thermally conductive manner.

15. The working medium accumulator according to claim 14, wherein at least two main steam channels are formed between two of the sheet layers, and wherein at least one of these main steam channels has a larger cross section.

16. The working medium accumulator according to claim 11, wherein the surfaces of the sheet layers comprise machining for improving a wettability with the working medium, which is formed using galvanic treatment in particular.

17. A heat exchanger comprising:
a first working medium accumulator;
a second working medium accumulator,
wherein a working medium is displaced between the first and second working medium accumulators, and
wherein one of the first or second working medium accumulators comprises:
a plurality of layers of metal sheets, wherein at least some of the sheet layers are contacted with a further structure in a thermally conductive manner, and wherein the sheet layers are disposed one above the other in a stacked manner; and
a sorbent disposed on at least one side of a particular sheet layer for the adsorption and desorption of the working medium, the sorbent having a thermally highly conductive and/or bonded connection with the sheet layer.

18. The heat exchanger according to claim 17, wherein each of the two working medium accumulators is designed according to claim 1.

19. The heat exchanger according to claim 17, wherein the two working medium accumulators are accommodated in a common housing, wherein the structures, which are contacted in a thermally conductive manner, are in the form of tubes which carry at least one fluid and extend through end-face bases of the housing.

20. The heat exchanger according to claim 19, wherein the heat exchanger is a module, wherein at least two of the modules are stacked sequentially in the direction of the tubes in a fluid-tight manner.

21. The heat exchanger according to claim 20, wherein the bases comprise a sealing surface, and wherein the sealing surface interacts with a seal to ensure fluid-tight stacking.

22. The heat exchanger according to claim 21, wherein a cistern is attached to the heat exchanger in a fluid-tight manner via the sealing surface.

23. The heat exchanger according to claim 19, wherein a housing jacket and a base enclose a closed hollow space in which the working medium accumulators are disposed.

24. A heat pump comprising
a plurality of heat exchangers, each of the heat exchangers having at least a first zone and a second zone for the displacement of a working medium disposed in the heat exchanger depending on thermodynamic state variables, each of the heat exchangers being thermally connectable via the first zone thereof to a first flow duct of the heat exchanger through which a first fluid flows, and via a second zone thereof to a second flow duct of the heat exchanger through which a second fluid flows thereby enabling thermal energy to be exchanged between one of the fluids and one of the zones; and
a valve system, wherein the flow ducts of one of the zones are interconnected to one another sequentially via the valve system and an interconnecting sequence changes in the course of an operation of the heat pump by way of the valve system,
wherein the first working medium accumulator is disposed in the first zone and the second working medium accumulator is disposed in the second zone, and
wherein at least one of the heat exchangers is a heat exchanger according to claims 17.

25. The working medium accumulator according to claim 1, wherein the sorbent is activated carbon
